(19) United States
(12) Patent Application Publication
(10) Pub. No.: US 2005/0069655 A1
(43) Pub. Date: Mar. 31, 2005

(54) Ink jet recording medium

(75) Inventors: Hiroshi Yamamoto, Shizuoka-ken (JP); Shinichi Teramae, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/948,466

(22) Filed: Sep. 24, 2004

(30) Foreign Application Priority Data
Sep. 25, 2003 (JP) 2003-333373

(51) Int. Cl. B41M 5/00

(52) U.S. Cl. 428/32.18

(57) ABSTRACT

An ink jet recording medium having an ink receiving layer on a support, wherein the support comprises a composition containing thermoplastic resin fine particles and a white pigment at least on the receiving layer forming surface side which at least the ink receiving layer is formed, and the support is subjected to heating and pressing treatment in a temperature range of not less than the glass transition temperature of the thermoplastic resin fine particles.

### CROSS-REFERENCE TO RELATED APPLICATION

This application claims priority under 35 USC 119 from Japanese Patent Application No. 2003-333373 the disclosure of which is incorporated by reference herein.

### BACKGROUND OF THE INVENTION

1. Field of the Invention

The present invention relates to an ink jet recording medium having printing properties suitable for ink jet recording which employs liquid inks such as aqueous and oil-based inks or solid inks which are solid at room temperature and used for printing images in the fused and fluidized state.

2. Description of the Related Art

With the recent rapid progress of the communication industry, various information processing systems have been developed and various recording methods and devices suitable for use in these information processing systems have also been developed and already in use. Among the recording methods above, ink jet recording method has been widely used not only in offices but also in homes, as the ink jet method allows printing on various recording materials and the hardware (devices) thereof is relatively low-cost, more compact, and more silent.

In addition, with the recent trend of ink jet printers toward higher-resolution and in the progress of the hardware (devices), diverse medium for ink jet recording has been developed. More recently, some ink jet printers allow printing of so-called photorealistic high-quality images. Properties required especially for the ink jet recording medium include in general, (1) quick drying property (high ink-absorbing rate), (2) suitable and uniform diameter of ink dots (absence of ink bleeding), (3) favorable graininess, (4) high circularity of printed dots, (5) high color density, (6) higher chroma saturation (absence of dullness), (7) favorable light fastness, gas resistance, and water resistance of printed image portions, (8) higher whiteness of recording surface, (9) favorable storage stability of recording medium (absence of yellowing and image bleeding over an extended period of time), (10) deformation resistance and favorable dimensional stability (suppressed curling), (11) favorable traveling characteristics through a machine, and the like. In addition, for application as photographic glossy papers, which are used for printing so-called photorealistic high-quality images, glossiness, surface smoothness, the silver halide photographic printing paper-like touch, and the like are also demanded in addition to the properties above.

For example, ink jet recording sheets having a porous colorant-receiving layer, which contains fine inorganic pigment particles and a water-soluble resin and has a high void percentage, formed on a support are disclosed in Japanese Patent Application Laid-Open (JP-A) Nos. 10-119423 and 10-217601. In particular, among these recording materials, an ink jet recording sheet that contains a colorant-receiving layer having a porous structure and employs silica as the inorganic pigment fine particles is described to have a superior ink absorptive property, a larger ink receiving capacity allowing printing of high-resolution images, as well as a high glossiness because of the structure.

In order to provide ink jet recording medium superior in glossiness, planarity, and image quality, resin-coated papers laminated with a polyethylene resin on both faces of a paper base support have hitherto been commonly used as the support for the ink jet recording medium. However, the resin-coated papers do not absorb ink solvents contained in such inks. Accordingly, when used as the support, the resin-coated papers carried the problem of image bleeding over time, as the ink solvents do not evaporate sufficiently fast when the medium are stored in files immediately after printing.

### SUMMARY OF THE INVENTION

Currently, there are no ink jet recording medium having the glossiness, high planarity, and high-quality image forming ability at the same level as the case where the resin-coated papers are used as the support and at the same time having a high ink solvent absorptive property and thus suppressing the loss of image definition over time.

An object of the present invention is to provide an inkjet recording medium that includes a support having a composition allowing permeation of the ink solvents in ink-jet inks at least on the recording face thereof, which is superior in planarity and glossiness, has a favorable ink absorptive property, allows printing of high-quality images, and is superior in resistance to the bleeding of formed images over time.

According to the invention, when a paper base support or the like, which is more vulnerable to deterioration in glossiness, planarity, and high-quality image forming ability, is used as the support, the support is not coated with a resin but with a composition containing thermoplastic resin fine particles, and additionally subjected to heating and pressing treatment at a temperature of not less than the glass transition temperature of the resin fine particles contained in the composition. The inventors have found that such treatments give a superior solvent absorptive performance while upholding the favorable glossiness and high-quality image forming ability. The invention has been achieved based on these findings.

A first aspect of the present invention is to provide an ink jet recording medium comprising a support and an ink receiving layer formed thereon, wherein the support comprises a composition having thermoplastic resin fine particles and a white pigment at least on the receiving layer forming surface side on which an ink receiving layer is formed, and the support is subjected to heating and pressing treatment in a temperature range not less than the glass transition temperature of the thermoplastic resin fine particles.

The invention provides an ink jet recording medium containing a composition that is capable of permeating the ink solvents in ink-jet inks on the recording face of the support, that is superior planarity and glossiness, has favorable ink absorptive properties, allows formation of high-quality images, and has an excellent resistance to the bleeding of printed images over time.

### DETAILED DESCRIPTION OF THE INVENTION

Ink Jet Recording Medium

The ink jet recording medium according to the present invention has a composition containing thermoplastic resin fine particles and a white pigment in any desired shape (e.g., layer form or the like) at least on the receiving layer forming surface side on which one ink receiving layer is formed. The ink jet recording medium of the invention comprises a support that absorbs the ink solvent by allowing penetration thereof contained in an ink-jet ink ejected onto the ink receiving layer during recording. Hereinafter, the ink jet recording medium of the invention will be described in detail.

The ink jet recording medium of the invention contains a composition having thermoplastic resin fine particles and a white pigment (hereinafter, referred to simply as the “composition”) and additionally, at least one ink receiving layer on a support that is subjected to heating and pressing treatment at a temperature of not less than the glass transition temperature of the thermoplastic resin fine particles contained in the composition. The ink jet recording medium of the invention may provide additionally other layers if necessary.

Support

The support according to the invention has a composition containing thermoplastic resin fine particles and a white pigment at least on the receiving layer forming surface side thereof on which an ink receiving layer is formed. The support according to the invention may contain the composition in the layer form (undercoat layer). For example, the undercoat layer may be favorably formed in the layer form in such a manner that an ink receiving layer can be formed over the undercoat layer that is formed on the face of a desired base support on which an ink receiving layer is to be formed. Hereinafter, such an undercoat layer is referred to as the “ink solvent absorptive undercoat layer”.

In this construction, the support according to the invention absorbs a greater amount of ink solvents contained in the ink ejected onto the ink receiving layer, which in turn, eliminates effectively the image bleeding over time.

Specifically, a favorable embodiment of the support according to the invention is a support comprising a base support selected as desired (preferably, paper base support), an ink receiving layer, and an ink solvent absorptive undercoat layer formed by using the composition on the receiving layer forming surface side of the base support. The ink solvent absorptive undercoat layer is formed on the face on which at least one ink receiving layer is formed of the base support (preferably, paper base support). The ink solvent absorptive undercoat layers may be formed on both faces of the paper base support depending on the purpose. The base support will be described below in detail.

As described above, presence of an ink solvent absorptive undercoat layer between the base support and the ink receiving layer allows permeation of the ink solvent contained in the ink ejected onto the ink receiving layer through the ink receiving layer into the ink solvent absorptive undercoat layer and absorption therein, thus reducing the amount of the ink solvent remaining in the ink receiving layer. The absorption of ink solvent is particularly effective in preventing image bleeding over time.

According to the invention, after formed in the form having the composition described above (preferably, in the form having an ink solvent absorptive undercoat layer) on the base support, the composition is further heat-pressed in a temperature range of not less than the glass transition temperature of the thermoplastic resin fine particles contained in the composition (heating and pressing treatment). Such the treatment provides the ink receiving layer formed over the composition with being laminated (preferably, ink solvent absorptive undercoat layer), with high glossiness, high planarity, and high-quality image forming ability.

The heating and pressing treatment may be performed, for example, by calendering the support (preferably, base support and more preferably, paper base support), on which the composition having thermoplastic resin fine particles and a white pigment is previously applied (preferably, as an ink solvent absorptive undercoat layer), by means of soft and/or super calendering machines wherein at least one of the paired rolls therein is a metal roll. In such a case, the heating and pressing treatment may be performed most suitably under the condition such that the surface temperature of metal roll is not less than the glass transition temperature (hereinafter, abbreviated simply to Tg) of the thermoplastic resin fine particles contained in the composition and the nip pressure between the pair of rolls is 50 to 400 kg/cm. The details of the treatment will be described below.

In particular, use of a paper base support as the base support for support, formation of a layer containing resin fine particles (ink solvent absorptive undercoat layer) replacing a resin coat on the paper base support, and additional soft and/or super calendering (surface temperature of metal roll ≧Tg; and nip pressure: 50 to 400 kg/cm) at least of the ink solvent absorptive undercoat layer (together with the paper base support) jointly ensure the favorable glossiness and planarity and the high-quality image forming ability of the recording face having the ink solvent absorptive undercoat layer, i.e., the surface of the ink receiving layer formed on the paper base support via the ink solvent absorptive undercoat layer and at the same time improve absorption of the ink solvent, thus effectively avoiding the bleeding of the printed image over time.

Composition

The composition according to the invention contains at least thermoplastic resin fine particles and a white pigment. The composition may contain other components if necessary. The composition may be used favorably in the form of a dispersion containing the thermoplastic resin fine particles and the white pigment. The composition may be used favorably, for example, in the form of (1) a dispersion prepared by adding and dispersing a white pigment in a dispersion of thermoplastic resin fine particles in a desired solvent, or, (2) a dispersion prepared by mixing a dispersion of thermoplastic resin fine particles and a dispersion of a white pigment. The composition prepared in the dispersion form may be applied, for example as the coating solution, onto the base support surface (preferably, paper base support) by any one of the methods known in the art such as coating and the like. For example, a layer of the composition (ink solvent absorptive undercoat layer) may be formed by coating.

If an ink solvent absorptive undercoat layer is formed by application for example according to the method (2) above, a latex dispersion of thermoplastic resin fine particles previously dispersed in water and a pigment dispersion of a white pigment dispersed in water are first prepared, and then a coating solution for forming the ink solvent absorptive undercoat layer wherein these dispersions are mixed and stirred uniformly (together with other components if necessary) (hereinafter, referred to as the “coating solution for ink solvent absorptive undercoat layer”) is prepared. Alternatively, if the ink solvent absorptive undercoat layer is formed according to the method (1), one of thermoplastic resin fine particles and a white pigment is dispersed in water, and another is then added to the dispersion (together with other components if necessary), and the resulting mixture is further dispersed well to give a homogeneous coating solution for ink solvent absorptive undercoat layer. The ink solvent absorptive undercoat layer can be suitably formed by coating and drying the coating solution for ink solvent absorptive undercoat layer thus obtained onto a paper base support (via another layer if needed) according to any one of the coating methods known in the art.

In addition to the coating method, the ink solvent absorptive undercoat layer may be formed by immersing the base support in the coating solution for ink solvent absorptive undercoat layer thus obtained or by spraying the coating solution for ink solvent absorptive undercoat layer onto the base support.

The thickness of the ink solvent absorptive undercoat layer is preferably in the range of 2 to 20 g/m² as dry coating amount. The dry coating amount is more preferably in the range of 4 to 20 g/m². The ink solvent absorptive undercoat layer having a dry coating amount in the above range suppresses the penetration of the coating solution for the ink receiving layer as will be described below that is formed on the ink solvent absorptive undercoat layer, and thus is effective in providing superior glossiness and improving the appearance of the coated surface of ink receiving layer and the permeability of ink solvent through the layer, consequently effectively exerting a suppressive effect on the bleeding over time. In addition, it also prevents uneven coating due to an excessive coating amount.

The coating solution for ink solvent absorptive undercoat layer may be suitably coated by any one of the coating methods known in the art: for example, blade coating method, bar coating method, spray coating method and the like. The concentration of solid matters in the coating solution for ink solvent absorptive undercoat layer is preferably in the range of 15 to 65% by mass.

Hereinafter, the thermoplastic resin fine particles and the white pigments, constituents of the composition, will be described.

The thermoplastic resin fine particles are not particularly limited, and may be selected and used appropriately from the fine particles of known thermoplastic resins and the latexes thereof, such as polyolefin resins (e.g., homopolymers of α-olefins such as polyethylene and polypropylene, and the mixtures thereof). Among them, latexes are more favorable, and examples thereof include acrylic latex, acrylic silicone latex, acrylic epoxy latex, acrylic styrene latex, acrylic urethane latex, styrene-butadiene latex, acrylonitrile-butadiene latex, vinyl acetate latex, and the like. The thermoplastic resin fine particles preferably contain at least one of them.

Specific examples of the thermoplastic resins are hybrid-type emulsion Aquabrid series products, manufactured by Daicel Chemical Industries, Ltd., (e.g., Aquabrid 903, ASi-86, ASi-91, 4635, 4901, MSi-04S, AU-124, AU-131, AEA-61, AEC-69, and AEC-162) and the like.

The thermoplastic resin fine particles may be used alone or in combination of two or more.

The glass transition temperature (Tg) of the thermoplastic resin fine particles is preferably 5 to 70° C., and more preferably 15 to 70° C. Thermoplastic resin fine particles having a Tg in the above range eliminate the problems of skimming and the like of the solution for the ink solvent absorptive undercoat layer (e.g., coating solution) and thus allow easier handling during production. In addition, such thermoplastic resin fine particles eliminates the disadvantages that because of the fine particles having a higher Tg, the calendering temperature should be raised significantly for obtaining desired glossiness, consequently causing the support to adhere to the metal roll surface more easily and the surface of the resulting substrate to become irregular, and easily provides the ink solvent absorptive undercoat layer superior in glossiness and planarity.

In addition, the minimum layer forming temperature of the thermoplastic resin fine particles is preferably 5 to 60° C. and more preferably 15 to 60° C. In particular, a minimum layer forming temperature in the above range, which enables coating of the thermoplastic resin fine particles, eliminates difficulties in handling during production such as the skimming of the solution for ink solvent absorptive undercoat layer (e.g., coating solution) and the like. In addition, it also eliminates deterioration in the appearance of coated surface thereof due to increased penetration of the coating solution for ink receiving layer described below when applied and allows preparation of a microporous layer sufficiently permeating the ink solvents rapidly. A layer prepared only by coating the solution containing the composition (e.g., coating solution) does not provide favorably glossiness, but soft calendering of the layer after coating provides a microporous layer higher in glossiness.

When the composition is applied in the layer form, the content of the thermoplastic resin fine particles in the ink solvent absorptive undercoat layer is preferably 15 to 95%, more preferably 30 to 90% by mass with respect to all solid matter in the layer. A content particularly in the above range can obtain permeability of the ink solvent and more effective prevention of the bleeding over time, without impairing the glossiness and planarity of the layer after calendering.

Examples of the white pigments include titanium oxide, barium sulfate, barium carbonate, calcium carbonate, lithopone, alumina white, zinc oxide, silica antimony trioxide, titanium phosphate, aluminum hydroxide, kaolin, clay, talc, magnesium oxide, magnesium hydroxide, and the like. These pigments may be used alone or in combination of two or more. Among them, titanium oxide is particularly preferable from the viewpoints of whiteness, dispersibility and stability.

The particle size of white pigment is preferably 0.1 to 0.5 μm. Particularly white pigments having particles size in the above range can prevent effectively decrease in whiteness and glossiness.

The titanium oxides include rutile type and anatase type, and may be used alone or in combination. Further, the titanium oxides may be produced by the sulfuric acid or chlorine method. The titanium oxide may be selected suitably from those surface-treated with an inorganic substance such as hydrated alumina, hydrated silicon dioxide, or zinc oxide; those surface-treated with an organic substance such as trimethylolmethane, trimethylolethane, trimethylolpropane, 2,4-dihydroxy-2-methylpentane or the like; those surface-treated with a siloxane such as polydimethylsiloxane; and the like.

The refractive index of the white pigment is preferably 1.5 or more. White pigments having a refractive index in the above range provide high-quality images.

The specific surface area of the white pigment as determined by the BET method is preferably less than 100 m²/g. White pigments having a specific surface area in the above range suppress penetration of the coating solution into the support during coating for formation of the ink receiving layer and increase the ink absorptive capacity of the resulting layer.

The BET method is a method of determining the surface area of powders by gas-phase adsorption, more specifically the specific surface area, i.e., the total surface area per g of a sample as determined from the absorption isotherm. Nitrogen gas is commonly used as the adsorption gas. The amount of adsorption is commonly determined by the change in pressure or volume of the adsorbed gas. One of the most famous equations for describing the adsorption isotherm of multimolecular systems is the equation of Brunauer, Emmett, and Teller (BET equation). The surface area is calculated by multiplying an adsorption amount determined by the BET equation by the surface area occupied by an adsorbed molecule.

If an ink solvent absorptive undercoat layer containing a white pigment is formed by using the composition, the content of the white pigment in the ink solvent absorptive undercoat layer may vary according to the kinds of the white pigment and thermoplastic resin used and the thickness of the layer, but is preferably about 50 to 200% by mass with respect to the weight of the thermoplastic resin fine particles.

The ink solvent absorptive undercoat layer may contain other additives known in the art such as an antioxidant and the like.

The thickness of the ink solvent absorptive undercoat layer formed by using the composition is preferably in the range of 1 to 30 μm, and more preferably in the range of 5 to 30 μm. Adjustment of the layer thickness in the range above leads to improved surface glossiness and enhanced whiteness of the layer after calendering even when a small amount of white pigment is used, and further suppresses more efficiently the bleeding over time, which may often occur when the printed image recording medium is stored in files immediately after printing, because of faster penetration of the ink solvent.

Base Support

The support according to the invention preferably contains a base support. In addition, the support is favorably contains an ink solvent absorptive undercoat layer on the base support. The base supports include, for example, transparent supports made of transparent materials such as plastics, and opaque supports made of opaque materials such as paper and the like.

Liquid-absorbing materials, especially paper base supports, are preferable as the base support. Use of a paper base support as the support according to the invention allows absorption of the ink solvent which passes through the ink solvent absorptive undercoat layer into the paper base support by the liquid-absorbing capacity of its own.

The paper base support may be a natural pulp paper containing a common natural pulp as the main component; a mixed paper containing a natural pulp and a synthetic fiber; a synthetic fiber paper containing a synthetic fiber as the main component; or a so-called synthetic paper, which is produced from a synthetic resin film of polystyrene, polyethylene terephthalate, polypropylene, or the like. Natural pulp papers (hereinafter, referred to simply as the “base paper”) are particularly preferable as the paper base support. The base paper may be a neutral paper (pH: 5 to 9) or an acidic paper, but is preferably a neutral paper.

The base paper contains a natural pulp selected from softwoods or hardwoods as the main component, and additionally if necessary a filler such as clay, talc, calcium carbonate, or a ureresin fine particles; a sizing agent such as a rosin, alkylketene dimer, higher aliphatic acid, epoxidized aliphatic acid amide, paraffin wax, or alkenyl succinate; a paper-strength additive such as starch, polyamide polyamine epichlorohydrin, or polyacrylamide; a fixing agent such as aluminum sulfate, or a cationic polymer; or the like. A softening agent such as a surfactant or the like may also be added. A synthetic paper made from synthetic pulp may be used, replacing those from natural pulps. Alternatively, a paper from both natural and synthetic pulps mixed at an arbitrary ratio may also be used. Among them, hardwood pulps shorter in fiber length are preferably as they provide papers higher in surface smoothness. The freeness of the pulp used is preferably in the range of 200 to 500 ml (C.S.F), and more preferably in the range of 300 to 400 ml.

The paper base support may contain additionally other component such as a sizing agent, softening agent, paper strength additive, and fixing agent. The sizing agents include rosins, paraffin waxes, higher aliphatic acid salts, alkenyl succinate salts, aliphatic acid anhydrides, styrene-maleic anhydride copolymers, alkylketene dimers and epoxidized aliphatic acid amides. The softening agents include reaction products from maleic anhydride copolymers and polyalkylene polyamines and higher aliphatic acid quaternary ammonium salts. The paper strength additives include polyacrylamide, starch, polyvinyl alcohol, melamine-formaldehyde condensates, gelatin, and the like. The fixing agents include aluminum sulfate, polyamide polyamine epichlorohydrins, and the like. Additionally, a dye, fluorescence dye, anti-static agent or the like may be added if necessary.

The paper base support is preferably subjected to an activating treatment such as a corona discharge, flame, glow discharge, or plasma treatment before forming the ink solvent absorptive undercoat layer described above.

Calendering

In the invention, it is preferable to calender the base support (preferably, paper base support) on which the composition (preferably, ink solvent absorptive undercoat layer) is coated at least on the ink receiving layer forming surface side thereof. The calendering may be performed, by using a soft or a super calendering machine wherein at least one of the paired rolls is a metal roll (preferably, consisting of a metal and a resin roll) or using both soft and super calendering machines, under the condition such that the surface temperature of the metal roll is kept at a temperature of not less than the glass transition temperature of the thermoplastic resin fine particles and the nip pressure between the roll nips of the pair of rolls is 50 to 400 kg/cm.

Hereinafter, the soft and super calendering machines equipped with metal and resin rolls will be described in detail. The metal roll is not particularly limited in its material or the like, if the metal roll is a cylindrical or columnar roll having a smooth surface and a heating structure inside, and may be properly selected from the metal rolls known in the art. In addition, the metal roll becomes contact with the recording surface of the support, i.e., the surface on which the ink receiving layer is formed as will be described below during calendering. Accordingly, the surface of the metal roll preferably has a lower surface roughness. More specifically, the surface roughness, as specified in JIS B0601, is preferably 0.3 s or less and more preferably 0.2 s or less.

In general, the surface temperature of the metal roll during the treatment is preferably 70 to 250° C., when only the base paper is processed. In contrast, when the paper base support having an ink solvent absorptive undercoat layer described above is processed, the surface temperature of the metal roll during the treatment is preferably not less than the glass transition temperature Tg of the thermoplastic resin fine particles contained in the ink solvent absorptive undercoat layer, and more preferably more than Tg+40° C.

The resin roll may be properly selected form synthetic resin rolls including those made of a polyurethane resin or polyamide resin, or the like. The Shore D hardness of the resin roll is preferably 60 to 90.

The nip pressure between the pair of rolls having the metal roll is preferably 50 to 400 kg/cm and still more preferably 100 to 300 kg/cm. As described above, the soft and/or super calendering treatments by using a pair of rolls are preferably performed once or twice.

As described above, especially when a liquid-absorbing paper base support is used as the base support, construction of an additional ink solvent absorptive undercoat layer on the paper base support for absorption of the ink solvent of the printed ink eliminates the problems of easily deterioration in glossiness, planarity, and quality-image forming ability. At the same time, addition of the solvent permeability to the layer allows effective prevention of the bleeding over time that is caused by the ink solvents remaining therein as it is not evaporated or removed immediately after printing.

Ink Receiving Layer

The ink jet recording medium of the invention contains an additional ink receiving layer formed on the composition (preferably, ink solvent absorptive undercoat layer) of the support formed as described above. The ink receiving layer preferably contains a water-soluble resin, a cross-linking agent that can crosslink the water-soluble resin, fine particles, and a mordant. The ink receiving layer may contain other components if necessary such as a surfactant and the like.

Ink-absorbing capacity of the ink receiving layer is improved by porous structure formed by containing the fine particles in the ink receiving layer. In particular, when the content of the fine particles in the solid matters of the ink receiving layer is 50% or more, more preferably 60% by mass, the ink receiving layer has a more favorable porous structure, further increasing the ink absorptive property thereof. Here, the content of the fine particles in the solid matters of the ink receiving layer is a content calculated with respect to the components other than water in the composition for the ink receiving layer.

The ink receiving layer having the porous structure is a layer having a void percentage of 50 to 75% and preferably of 60 to 70%. When the void percentage is 50 to 75%, the ink absorptive property is large enough to eliminate the problem of pulverization due to deficiency of binder. For keeping the quality of the ink jet recording medium, the thickness of the ink receiving layer is preferably 20 to 40 μm. Similarly, the 60° glossiness thereof is preferably 30 to 70%.

Fine Particles

The fine particles may be organic fine particles or inorganic fine particles. Favorable examples of the organic fine particles include polymeric fine particles obtained by emulsion polymerization, microemulsion polymerization, soap-free polymerization, seeding polymerization, dispersion polymerization and suspension polymerization, and specific examples thereof include powders, latexes, emulsive polymeric fine particles, and the like of polyethylene, polypropylene, polystyrene, polyacrylate, polyamide, silicone resins, phenol resins, natural polymers, and the like.

Alternatively, examples of the inorganic fine particles include fine particles of silicfine particles, colloidal silica, titanium dioxide, barium sulfate, calcium silicate, zeolite, kaolinite, halloysite, mica, talc, calcium carbonate, magnesium carbonate, calcium sulfate, pseudoboehmite, zinc oxide, zinc hydroxide, aluminfine particles, aluminium silicate, calcium silicate, magnesium silicate, zirconium oxide, hydroxide zirconium, cerium oxide, lanthanum oxide, yttrium oxide, and the like.

Among them, inorganic fine particles are preferable, from the viewpoints of ink absorptive property and image stability. Silicfine particles, colloidal silica, aluminfine particles, or pseudoboehmite is preferable for preparing a more favorable porous structure.

Silicfine particles are commonly classified roughly into wet method particles and dry method (gas phase process) particles according to the method of manufacture. By the wet method, silicfine particles are mainly produced by generating an activated silica by acid decomposition of a silicate, polymerizing properly the activated silica, and coagulating the resulting polymeric silica to give a hydrated silica. Alternatively by the gas phase process, vapor-phase process silica (anhydrous silica) particles are mainly produced by high-temperature gas-phase hydrolysis of a silicon halide (flame hydrolysis process), or by reductively heating and vaporizing quartz and coke in an electric furnace by applying an arc discharge and then oxidizing the vaporized silica with air (arc method). The “vapor-phase process silica” means an anhydrous silicfine particles produced by the gas phase process. Vapor-phase process silicfine particles are especially preferable as the silicfine particles according to the invention.

The vapor-phase process silicas are different in the density of silanol group on the surface and the presence of voids therein and exhibit different properties from hydrated silicas. The vapor-phase process silicas are suitable for forming a three-dimensional structure higher in void percentage. The reason is not clearly understood. In the case of hydrated silicfine particles have a higher density of the silanol groups at 5 to 8 pieces/nm² on its surface. Thus the silicfine particles tend to coagulate densely. While, vapor-phase-process silica particles have a lower density of the silanol groups at 2 to 3/nm² on its surface. Therefore, vapor-phase process silica seems to cause more scarce, softer coagulation (flocculation), consequently leading to a structure higher in void percentage.

The vapor-phase process silica has an extremely high specific surface area, and provides the layer higher in ink absorption and retention capacity. In addition, the vapor-phase process silica has a lower refractive index, and thus if dispersed to a suitable particles diameter, provides the ink receiving layer with better transparency, and higher color density and favorable coloring of printed images. The transparency of ink receiving layer is important from the viewpoint of obtaining a high color density and favorable coloring glossiness not only for applications wherein the transparency is required such as OHP sheets and the like, but also for applications as recording sheets such as photographic glossy papers and the like.

The average primary particles diameter of the vapor-phase process silica is preferably 50 nm or less, more preferably 20 nm or less, particularly preferably 10 nm or less, and most preferably 3 to 10 nm. Vapor-phase process silica particles tend to bind to each other via hydrogen bonds between silanol groups, and thus silica particles having an average primary particles diameter of 50 nm or less provides a structure having high void percentage, thus effectively improving the ink-absorbing property.

The silicfine particles may be used together with other fine particles described above. If another fine particles and the vapor-phase process silica are used together, the content of the vapor-phase process silica in all fine particles is preferably 30% by mass or more and more preferably 50% by mass or more.

Aluminfine particles, alumina hydrate, and the mixture or the complex thereof are also preferable as the inorganic fine particles. Among them, alumina hydrate is preferable, as it absorbs and holds inks well. In particular, pseudoboemite (Al₂O₃.nH₂O) is preferable. Alumina hydrate may be used in a variety of forms. Alumina hydrate is preferably prepared from using boehmite in the sol state as the starting material, as it provides smoother layers more easily.

The average pore radius of pseudoboemite is preferably 1 to 25 nm and more preferably 2 to 10 nm. The pore volume thereof is preferably 0.3 to 2.0 ml/g, and more preferably 0.5 to 1.5 ml/g. The average pore radius and the pore volume are determined by the nitrogen absorption/desorption method. These values may be determined, for example, by using a gas absorption/desorption analyzer (e.g., trade name: Omnisorp 369, manufactured by Beckman Coulter, Inc.).

Among aluminfine particles, gas phase process aluminfine particles having a greater specific surface area are preferable. The average primary particles diameter of the gas phase process aluminfine particles is preferably 50 nm or less and more preferably 20 nm or less. Colloidal silicas having an average primary particles diameter of 50 nm or less are also included in preferable examples.

The fine particles may be used in the manner similar to the embodiments disclosed in, for example, JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, 2001-301314, and the like.

Water-Soluble Resin

Examples of the water-soluble resins used for the ink receiving layer include polyvinyl alcohol resins having a hydroxy group as the hydrophilic constitutional unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinylacetal, etc.]; cellulosic resins [methylcellulose (MC), ethylcellulose (EC), hydroxyethylcellulose (HEC), carboxymethylcellulose (CMC), hydroxypropylcellulose (HPC), hydroxyethylmethylcellulose, hydroxypropylmethylcellulose, etc.]; chitins; chitosans; starch; ether bond-containing resins [polyethylene oxide (PEO), polypropylene oxide (PPO), polyethylene glycol (PEG), polyvinyl ether (PVE), etc.]; carbamoyl group-containing resins [polyacrylamide (PAAM), polyvinylpyrrolidone (PVP), polyacrylic acid hydrazide, etc.]; and the like. In addition, resins having a carboxyl group as the dissociative group, such as polyacrylate salts, maleic acid resins, and alginate salts; gelatins, and the like, are also included. The water-soluble resins may be used alone or in combination of two or more.

Among them, polyvinyl alcohol resins are particularly preferable. Examples of the polyvinyl alcohols include those described in Japanese Patent Application Publication (JP-B) Nos. 4-52786, 5-67432, and 7-29479; Japanese Patent No. 2537827; JP-B No. 7-57553; Japanese Patent Nos. 2502998 and 3053231; JP-A No. 63-176173; Japanese Patent No. 2604367; JP-A Nos. 7-276787, 9-207425, 11-58941, 2000-135858, 2001-205924, 2001-287444, 62-278080, and 9-39373; Japanese Patent No. 2750433; JP-A Nos. 2000-158801, 2001-213045, 2001-328345, 8-324105, and 11-348417; and the like. In addition, examples of the water-soluble resins except the polyvinyl alcohol resins include those described in paragraphs [0011] to [0014] of JP-A No. 11-165461.

The content of the water-soluble resin in the ink receiving layer is preferably 9 to 40%, more preferably 12 to 33% by mass with respect to the total weight of the solid matter in ink receiving layer. These water-soluble resins and the fine particles described above each may be a single-component substance or a multiple-component substance.

From the viewpoint of ensuring transparency of the ink receiving layer, selection of the kind of the water-soluble resin used in combination with the fine particles, especially with silicfine particles, is important. For combination with the vapor-phase process silica, polyvinyl alcohol resins are preferable as the water-soluble resin. Among them, polyvinyl alcohol resins having a saponification value 70 to 100% are preferable, and polyvinyl alcohol resins having a saponification value of 80 to 99.5% are particularly preferable.

The polyvinyl alcohol resins contain a hydroxyl group as the structural unit. Hydrogen bonding between the hydroxyl groups and the surface silanol groups on silicfine particles allows silicfine particles to form a three-dimensional network structure having secondary particles as the network chain units. This three-dimensional network structure thus constructed seems to be the cause of easier development of an ink receiving layer having a porous structure higher in void percentage and strength. In ink jet recording, the ink receiving layer having a porous structure obtained in this manner absorbs inks rapidly due to the capillary phenomenon, and provides printed dots superior in circularity without ink bleeding.

In addition, the polyvinyl alcohol resin may be used together with other water-soluble resins. When another water-soluble resin and the polyvinyl alcohol resin are used in combination, the amount of polyvinyl alcohol resin is preferably 50% or more, more preferably 70% by mass or more with respect to total water-soluble resins.

Ratio of the Fine Particles to the Water-Soluble Resin Contained

The ratio of the weight of fine particles x to the weight of water-soluble resin y (PB ratio: x/y) has a great influence on the structure and strength of the ink receiving layer. A larger weight ratio (PB ratio) tends to result in increase in void percentage, pore volume, and surface area (per unit weight) but decrease in density and strength.

The PB ratio (x/y) for the ink receiving layer is preferably 1.5 to 10, from the viewpoints of suppressing the decrease in layer strength and preventing cracking thereof when dried which may be caused due to an excessively larger PB value, and of preventing decrease in void percentage and thus in ink absorptive property due to an larger amount of voids eliminated more easily due to an excessively lower PB ratio.

When conveyed in paper-conveying systems of ink jet printers, a stress may be applied to the ink jet recording medium. Accordingly, the ink receiving layer should have sufficiently high layer strength. Also from the viewpoints of preventing cracking, peeling, or the like of the ink receiving layer when the ink jet recording medium are cut into sheets, the ink receiving layer should have sufficiently high layer strength. Considering the above, the PB ratio is preferably 5 or less.

On the other hand, from the viewpoint of ensuring the superior ink absorptive property in ink jet printers, the ratio is more preferably 2 or more.

For example, when a coating solution, containing a vapor-phase process silicfine particles having an average primary particles diameter of 20 nm or less and a water-soluble resin homogeneously dispersed in an aqueous solution at a PB ratio (x/y) of 2 to 5, is applied and dried on a support, a three-dimensional network structure having the secondary particles of silicfine particles as the network chains is formed. Such a coating solution provides easily a translucent porous layer having an average void diameter of 25 nm or less, a void percentage of 50 to 80%, a void specific volume of 0.5 ml/g or more, and a specific surface area of 100 m²/g or more.

Cross-Linking Agent

With respect to the ink receiving layer according to the invention, it is preferable that the layer containing fine particles, a water-soluble resin, and the like, contains additionally a cross-linking agent that allows crosslinking of the water-soluble resin, and thus is a porous layer hardened by the crosslinking reaction between the cross-linking agent and the water-soluble resin.

The crosslinking agent may be selected properly in relation to the water-soluble resin contained in the ink receiving layer. Boric acid or a boron compound is preferable, as it allows a rapider crosslinking reaction. Examples of the boron compounds include borax, borate salts [e.g., orthoborate salts, InBO₃, ScBO₃, YBO₃, LaBO₃, Mg₃(BO₃)₂, and CO₃(BO₃)₂], diborate salts [e.g., Mg₂B₂O₅, and CO₂B₂O₅], metaborate salts [e.g., LiBO₂, Ca(BO₂)₂, NaBO₂, and KBO₂], tetraborate salts [e.g., Na₂B₄O₇.10H₂O], pentaborate salts [e.g., KB₅O₈.4H₂O, Ca₂B₆O₁₁.7H₂O, and CsB₅O₅], and the like.

Among them, borax, boric acid, and borate salts are preferable from the viewpoint of rapider crosslinking reaction; boric acid is more preferably; and use of the compound together with polyvinyl alcohol, one of water-soluble resins, is particularly preferable.

The content of the cross-linking agent is preferably 0.05 to 0.50 part, more preferably 0.08 to 0.30 part by mass, with respect to 1 part by mass of the water-soluble resin. If the content of the cross-linking agent is in the above range, the water-soluble resin is crosslinked more efficiently, preventing cracking of the resulting layers.

For example, when gelatin is used as the water-soluble resin, compounds other than boron or a boron compounds described below may also be used as the cross-linking agent. Examples thereof include aldehyde compounds such as formaldehyde, glyoxal, and glutaraldehyde; ketone compounds such as diacetyl and cyclopentanedione; active halogen compounds such as bis (2-chloroethyurea)-2-hydroxy-4,6-dichloro-1,3,5-triazine and 2,4-dichloro-6-S-triazine.sodium salt; active vinyl compounds such as divinylsulfonic acid, 1,3-vinylsulfonyl-2-propanol, N,N′-ethylene bis (vinylsulfonylacetamide), and 1,3,5-triacryloyl-hexahydro-S-triazine; N-methylol compounds such as dimethylolurea and methylol dimethylhydantoin; melamine resins (e.g., methylol melamine and alkylated methylol melamines); epoxy resins; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidylether; ethylene imino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate, and chromium acetate; polyamine compounds such as tetraethylene pentamine; hydrazide compounds such as adipic acid dihydrazide; low-molecular weight compounds or polymers having 2 or more oxazoline groups; and the like. The cross-linking agents may be used alone or in combination of two or more.

The cross-linking agent may be added into the coating solution for ink receiving layer and/or the coating solution for forming the neighboring layer of the ink receiving layer (e.g., ink solvent absorptive undercoat layer), when the coating solution for forming ink receiving layer (hereinafter, referred to as the “coating solution for ink receiving layer”) is coated. Alternatively, the cross-linking agent may be supplied to the ink receiving layer, by coating the coating solution for ink receiving layer onto the ink solvent absorptive undercoat layer previously coated with a coating solution containing a cross-linking agent, or by coating and drying coating solution for ink receiving layer not containing a cross-linking agent and then overcoating the cross-linking agent solution.

For example, the cross-linking agent may be added favorably in the following manner. Here, the method will be described by taking a boron compound as an example. If the ink receiving layer is a layer prepared by crosslinking and hardening the coated layer prepared by coating the coating solution for ink receiving layer (first solution), the crosslinking and hardening may be performed by applying a basic solution (second solution) at pH 7.1 or more onto the coated layer, either (1) simultaneously with forming coated layer by applying the coating solution, or (2) before the coated layer obtained by coating the coating solution exhibits falling dry rate when dried. The boron compound, a cross-linking agent, may be contained either in the first or second solution. Alternatively, the boron compound may be contained both in the first and second solutions. Details will be described more specifically below.

Mordant

In the invention, a mordant is preferably added to the ink receiving layer, for further improvement in the water resistance and resistance to bleeding over time of formed images. Both organic mordants such as cationic polymers (cationic mordants) and inorganic mordants such as water-soluble metal compounds may be used as the mordant. Among them, organic mordants are preferable, and cationic mordants are more preferable.

Presence of the mordant at least in the upper layer portion of ink receiving layer generates an interaction with a liquid ink having an anionic dye as the colorant, and thus stabilizes the colorant. The presence of mordant also allows further improvement in the water resistance and the resistance to bleeding over time of formed images.

In such a case, the mordant may be contained either in the coating solution for ink receiving layer (first solution) or the basic solution (second solution) for forming the ink receiving layer, but is preferably contained in the second solution, which is different from the solution containing an inorganic fine particles (especially, vapor-phase process silica). It is because addition of the mordant directly into the coating solution for the ink receiving layer may result in coagulation in the presence of a vapor-phase process silica having anion electric charges. However, adoption of the method of separately preparing and applying the mordant-containing solution and the coating solution for ink receiving layer eliminates the concern about coagulation of inorganic fine particles, and broaden the range of choice for the mordant.

Polymeric mordants having a primary to tertiary amino group or a quaternary ammonium salt group as the cationic functional group are favorably used as the cationic mordant. Nonpolymeric cationic mordants may also be used.

Homopolymers from monomers having a primary to tertiary amino group or a salt thereof or a quaternary ammonium salt group (hereinafter, referred to as the “mordant monomer”) and copolymers or condensation polymers of the mordant monomers with other monomers (hereinafter, referred to as the “nonmordant polymer”) are more preferably as the polymeric mordant. These polymeric mordant may be used in the form of a water-soluble polymer or a latex particles dispersed in water.

Examples of the mordant monomers include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;
trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinyphenyl)ethylammonium chloride, N,N,N-triethyl-N-2-(3-vinyphenyl)ethylammonium chloride, N,N-diethyl-N-methyl-N-2-(4-vinyphenyl)ethylammonium chloride, N,N-diethyl-N-methyl-N-2-(4-vinyphenyl)ethylammonium acetate;
quarternary ammonium compounds prepared by reactions of methyl chloride, ethyl chloride, methyl bromide, ethyl bromide, methyl iodide or ethyl iodide with N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, or, N,N-diethylaminopropyl(meth)acrylamide; or the anion-exchanged sulfonate salts, alkylsulfonate salts, acetates or alkyl carboxylates thereof; and the like.

Specific compounds include, for example, monomethydiallylammonium chloride, trimethyl-2-(methacrlyloyloxy)ethylammonium chloride, triethyl-2-(methacrlyloyloxy)ethylammonium chloride, trimethyl-2-(acryloyloxy)ethylammonium chloride, triethyl-2-(acryloyloxy)ethylammonium chloride, trimethyl-3-(methacrlyloyloxy)propylammonium chloride, triethyl-3-(methacrlyloyloxy)propylammonium chloride, trimethyl-2-(methacylyloylamino)ethylammonium chloride, triethyl-2-(methacylyloylamino)ethylammonium chloride, trimethyl-2-(acryloylamino)ethylammonium chloride, triethyl-2-(acryloylamino)ethylammonium chloride, trimethyl-3-(methacylyloylamino)propylammonium chloride, triethyl-3-(methacylyloylamino)propylammonium chloride, trimethyl-3-(acryloylamino)propylammonium chloride, triethyl-3-(acryloylamino)propylammonium chloride;
N,N-dimethyl-N-ethyl-2-(methacrlyloyloxy)ethylammonium chloride, N,N-diethyl-N-methyl-2-(methacrlyloyloxy)ethylammonium chloride, N,N-dimethyl-N-ethyl-3-(acryloylamino)propylammonium chloride, trimethyl-2-(methacrlyloyloxy)ethylammonium bromide, trimethyl-3-(acryloylamino)propylammonium bromide, trimethyl-2-(methacrlyloyloxy)ethylammonium sulfonate, trimethyl-3-(acryloylamino)propylammonium acetate; and the like.

In addition, copolymerizable monomers such as N-vinylimidazole and N-vinyl-2-methylimidazole are also included.

Further, allylamine, diallyamine, the derivatives and salts thereof may also be used. Examples of these compounds include allylamine, allylamine hydrochloride, allylamine acetate, allylamine sulfate, diallyamine, diallyamine hydrochloride, diallyamine acetate, diallyamine sulfate, diallylmethylamine and the salts thereof (e.g., hydrochloride, acetate, and sulfate salts, and the like), diallylethylamine and the salts thereof (e.g., hydrochloride, acetate, and sulfate salts, and the like), diallyldimethylammonium salts (counter anions thereof including chloride, acetate, and sulfate ions), and the like. These allylamine and diallyamine derivatives are less polymerizable in the amine form, and thus are commonly polymerized in the salt form and desalted thereafter if necessary.

Polymers having a vinyl amine unit, which are prepared by polymerizing a polymerization unit such as N-vinyl acetamide, N-vinyl formamide, or the like and hydrolyzing the resulting polymer, and the salts thereof may also be used.

The nonmordant monomer described above is a monomer that does not contain a basic or cationic group such as a primary to tertiary amino group or a salt thereof, or a quaternary ammonium salt group, and thus does not interact or has a practically smaller interaction with the dye in ink-jet ink.

Examples of the nonmordant monomers include: (meth)acrylic acid alkyl esters: (meth)acrylic acid cycloalkyl esters such as cyclohexyl (meth)acrylate; (meth)acrylic acid aryl esters such as phenyl (meth)acrylate; aralkyl esters such as benzyl (meth)acrylate; aromatic vinyl compounds such as styrene, vinyltoluene, and α-methylstyrene; vinylesters such as vinyl acetate, vinyl propionate, and vinyl versatate; allyl esters such as allyl acetate; halogen-containing monomers such as vinylidene chloride and vinyl chloride; vinyl cyanides such as (meth)acrylonitrile; olefins such as ethylene and propylene; and the like.

(Meth)acrylic acid alkyl esters having an alkyl group having 1 to 18 carbons are preferable as the (meth)acrylic acid alkyl ester. Specific examples thereof include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, stearyl (meth)acrylate, and the like. Among them, methyl acrylate, ethyl acrylate, methyl methacrylate, ethyl methacrylate, and hydroxyethyl methacrylate are preferable. The nonmordant monomers may also be used alone or in combination of two or more.

Other favorable examples of the cationic mordants include polydiallydimethylammonium chloride, polymethacrlyloyloxyethyl-β-hydroxyethyldimethylammonium chloride, polyethyleneimine, polyallylamine and the derivatives thereof, polyamide-polyamine resins, cationized starch, dicyandiamide formalin condensates, dimethyl-2-hydroxypropylammonium salt polymers, polyamidine, polyvinylamine, dicyandiamide-formalin polycondensates represented by dicyan-based cationic resins, dicyanamide-diethylenetriamine polycondensates represented by polyamine-based cationic resins, epichlorohydrin-dimethylamine addition polymers, dimethyldiallylammonium chloride-SO₂ copolymers, diallyamine salt-SO₂ copolymers, (meth)acrylate-containing polymers having a quaternary ammonium salt group-substituted alkyl group in the ester portion, styryl polymers having a quaternary ammonium salt group-substituted alkyl group, and the like.

Specific examples of the cationic mordants include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236; U.S. Pat. Nos. 2,484,430, 2,548,564, 3,148,061, 3,309,690, 4,115,124, 4,124,386, 4,193,800, 4,273,853, 4,282,305, and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314; JP-B Nos. 5-35162, 5-35163, 5-35164, and 5-88846; JP-A Nos. 7-118333 and 2000-344990; Japanese Patent Nos. 2648847 and 2661677; and the like. Among them, polyallylamine and the derivatives thereof are preferably and diallydialkylcation polymers are structurally preferable.

Various allylamine polymers and the derivatives thereof known in the art may be used as the polyallylamine or the derivatives thereof. Examples of these derivatives include salts of polyallylamine and an acid (the acids include inorganic acids such as hydrochloric acid, sulfuric acid, phosphoric acid, and nitric acid; organic acids such as methanesulfonic acid, toluenesulfonic acid, acetic acid, propionic acid, cinnamic acid, and (meth)acrylic acid, and the combinations thereof; and allylamine partially converted to the salt is also included), derivatives of polyallylamine prepared by polymer reactions, and copolymers of polyallylamine and a other copolymerizable monomer [the monomers include typically (meth)acrylic esters, styrenes, (meth)acrylamides, acrylonitrile, vinylesters, and the like].

Specific examples of the polyallylamine and the derivatives thereof include those described in JP-B Nos. 62-31722, 2-14364, 63-43402, 63-43403, 63-45721, 63-29881, 1-26362, 2-56365, 2-57084, 4-41686, 6-2780, 6-45649, 6-15592, and 4-68622; Japanese Patent Nos. 3199227 and 3008369; JP-A Nos. 10-330427, 11-21321, 2000-281728, 2001-106736, 62-256801, 7-173286, 7-213897, 9-235318, 9-302026, and 11-21321; WO 99/21901 and 99/19372; JP-A No. 5-140213; Japanese Patent Application National Publication (Laid-Open) No. 11-506488; and the like.

Among the cationic mordants, diallydialkylcation polymers are preferable, and diallydimethylcation polymers are particularly preferable. The cationic mordant is preferably a cationic polymer having a weight-average molecular weight of 60,000 or less, more preferably of 40,000 or less, from the viewpoints of dispersibility, especially of preventing increase in viscosity.

The cationic mordant is also useful as the dispersant for the fine particles.

When added into the coating solution for ink receiving layer, the sulfate ion concentration in the coating solution is preferably 1.5% by mass or less, from the viewpoint of preventing increase in viscosity. The sulfate ion derives from the polymerization initiator or the like used during production of the cationic polymer. Accordingly, it is advantageous to use a cationic mordant prepared by using a polymerization initiator or the like that does not release sulfate ions, as the sulfate ions remain in the polymer.

The inorganic mordants include polyvalent water-soluble metal salts and hydrophobic metal salt compounds. Specific examples thereof include salts or complexes of metals such as magnesium, aluminium, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

More specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, cupric ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminium alum, basic polyhydroxy aluminum, aluminum sulfite, aluminum thiosulfate, polychlorinated aluminum, aluminium nitrate nonahydrate, aluminium chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconium ammonium carbonate, zirconyl stearate, zirconyl octoate, zirconyl nitrate, zirconium oxychloride, zirconium hydroxychloride, chromium acetate, chromium sulfate, manganese sulfate, magnesium chloride hexahydrate, magnesium citrate nonahydrate, sodium phosphotungstate, sodium tungsten citrate, undecatungstophosphoric acid n-hydrate, undecatungstosilicic acid 26-hydrate, molybdenum chloride, undecamolybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octoate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like.

Among the inorganic mordants, aluminium-containing compounds, titanium-containing compounds, zirconium-containing compounds, and metal compounds (salts or complexes) of the metals in group IIIB of the periodic table are preferable.

The amount of the mordant added in the ink receiving layer is preferably 0.01 to 5 g/m² and more preferably 0.1 to 3 g/m².

Other Components

The ink receiving layer according to the invention may additionally contain, if necessary, various additives known in the art such as acid, ultraviolet-absorbent, antioxidant, fluorescent whitening agent, monomer, polymerization initiator, polymerization inhibitor, anti-bleeding agent, antiseptic, viscosity stabilization agent, antifoamer, surfactant, antistatic agent, matting agent, anti-curl agent, water-resistance imparting agent, and the like.

The ink receiving layer according to the invention may contain the acid. Adjustment of the surface pH of the ink receiving layer to 3 to 8, preferably 3.5 to 6.0, by addition of an acid allows improvement in the yellowing resistance of the white portion of the resulting recording medium. The surface pH may be determined according to the A method (coating method) for measurement of surface PH specified by the Japanese Technical Association of the Pulp and Paper Industry (J.TAPPI), by using, for example, a pH-measuring set “model MPC” for determining the pH of paper surfaces manufactured by KYORITSU CHEMICAL-CHECK Lab., Corp., which complies with the A method.

Specific examples of the acids include formic acid, acetic acid, glycolic acid, oxalic acid, propionic acid, malonic acid, succinic acid, adipic acid, maleic acid, malic acid, tartric acid, citric acid, benzoic acid, phthalic acid, isophthalic acid, glutaric acid, gluconic acid, lactic acid, aspartic acid, glutamic acid, salicylic acid, salicylic acid metal salts (salt of Zn, Al, Ca, Mg, or the like), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sufanilic acid, sulfamic acid, α-resorcinic acid, β-resorcinic acid, γ-resorcinic acid, gallic acid, fluoroglycine, sulfosalicyclic acid, ascorbic acid, erythorbic acid, bisphenolic acid, hydrochloric acid, nitric acid, sulfuric acid, phosphoric acid, polyphosphoric acid, boric acid, boronic acid, and the like. The amount of the acid added is suitably determined so that the surface pH of the ink receiving layer becomes 3 to 8.

The acid may be used as a metal salt (e.g., a salt of sodium, potassium, calcium, cesium, zinc, copper, iron, aluminium, zirconium, lanthanum, yttrium, magnesium, strontium, cerium, or the like), or as an amine salt (e.g., a salt of ammonia, triethylamine, tributylamine, piperazine, 2-methylpiperazine, polyallylamine, or the like).

The ink receiving layer according to the invention preferably contains an additive for improving storage stability such as an ultraviolet absorbent, antioxidant, anti-bleeding agent, or the like.

The ultraviolet absorbents, antioxidants, and anti-bleeding agents that may be added include alkylated phenolic compounds (including hindered phenolic compounds), alkylthiomethylphenol compounds, hydroquinone compounds, alkylated hydroquinone compounds, tocopherol compounds, thiodiphenylether compounds, compounds having two or more thioether bonds, bisphenol compounds, O-, N- and S-benzyl compounds, hydroxybenzyl compounds, triazine compounds, phosphonate compounds, acylaminophenol compounds, ester compounds, amide compounds, ascorbic acid, amine-based antioxidants, 2-(2-hydroxyphenyl)benzotriazole compounds, 2-hydroxy benzophenone compounds, acrylates, water-soluble or hydrophobic metal salts, organic metal compounds, metal complexes, hindered amine compounds (including TEMPO compounds), 2-(2-hydroxyphenyl) 1,3,5-triazine compounds, metal deactivators, phosphite compounds, phosphonite compounds, hydroxylamine compounds, nitrone compounds, peroxide scavengers, polyamide stabilizers, polyether compounds, basic auxiliary stabilizers, nucleating agents, benzofuranone compounds, indolinone compounds, phosphine compounds, polyamine compounds, thiourea compounds, urea compounds, hydrazide compounds, amidine compounds, saccharide compounds, hydroxybenzoic acid compounds, dihydroxybenzoic acid compounds, trihydroxybenzoic acid compounds, and the like.

Among them, at least one compound selected from the group consisting of alkylated phenolic compounds, compounds having two or more thioether bonds, bisphenol compounds, ascorbic acid, amine-based antioxidants, water-soluble or hydrophobic metal salts, organic metal compounds, metal complexes, hindered amine compounds, polyamine compounds, thiourea compounds, hydrazide compounds, hydroxybenzoic acid compounds, dihydroxybenzoic acid compounds, and trihydroxybenzoic acid compounds is preferably contained therein.

Specific examples of the compounds include those described in JP-A Nos. 2002-307822, 10-182621, and 2001-260519; JP-B Nos. 4-34953 and 4-34513; JP-A No. 11-170686; JP-B No. 4-34512; EP 1138509; JP-A Nos. 60-67190, 7-276808, 2001-94829, 47-10537, 58-111942, 58-212844, 59-19945, 59-46646, 59-109055, and 63-53544; JP-B Nos. 36-10466, 42-26187, 48-30492, 48-31255, 48-41572, 48-54965, and 50-10726; U.S. Pat. Nos. 2,719,086,3,707,375, 3,754,919, and 4,220,711;
JP-B Nos. 45-4699 and 54-5324; European Patent laid-Open Nos. 223739, 309401, 309402, 310551, 310552, and 459416; German Patent Laid-Open No. 3435443; JP-A Nos. 54-48535, 60-107384, 60-107383, 60-125470, 60-125471, 60-125472, 60-287485, 60-287486, 60-287487, 60-287488,61-160287, 61-185483,61-211079, 62-146678,62-146680, 62-146679, 62-282885, 62-262047, 63-051174, 63-89877, 63-88380, 66-88381, 63-113536,63-163351, 63-203372, 63-224989, 63-251282, 63-267594, 63-182484, 1-239282, 2-262654, 2-71262, 3-121449, 4-291685, 4-291684, 5-61166, 5-119449,5-188687, 5-188686,5-110490, 5-1108437, and 5-170361; JP-B Nos. 48-43295 and 48-33212; U.S. Pat. Nos. 4,814,262 and 4,980,275; and the like.

The other additives may be used alone or in combination of two or more. The other additive may be added after solubilized in water, dispersed, dispersed in polymer, emulsified, converted into oil droplets, or contained in microcapsules. The amount of other additives added is preferably 0.01 to 10 g/m².

The surface of fine particles may be treated with a silane-coupling agent for the purpose of improving the dispersibility of the fine particles. Silane coupling agents having a coupling site as well as an organic functional group [e.g., vinyl group, amino group (primary to tertiary amino group or quaternary ammonium salt group), epoxy group, mercapto group, chloro group, alkyl group, phenyl group, ester group, or the like] may be used favorably.

In addition, the ink receiving layer according to the invention (coating solution for ink receiving layer) preferably contains a surfactant. The surfactant may be selected suitably from nonionic, ampholytic, anionic, cationic, fluorinated, and siliconated surfactants. The surfactants may be used alone or in combination of two or more.

Examples of the nonionic surfactants include polyoxyalkylene alkylethers and polyoxyalkylene alkylphenyl ethers (e.g., diethylene glycol monoethylether, diethylene glycol diethylether, polyoxyethylene laurylether, polyoxyethylene stearylether, polyoxyethylene nonylphenylether, and the like); oxyethylene.oxypropylene block copolymers; sorbitan aliphatic esters (e.g., sorbitan monolaurate, sorbitan monooleate, sorbitan trioleate, and the like); polyoxyethylene sorbitan aliphatic esters (e.g., polyoxyethylene sorbitan monolaurate, polyoxyethylene sorbitan monooleate, polyoxyethylene sorbitan trioleate, and the like); polyoxyethylene sorbitol aliphatic esters (e.g., polyoxyethylene sorbit tetraoleate and the like); glycerin aliphatic esters (e.g., glycerol monooleate and the like); polyoxyethylene glycerin aliphatic esters (polyoxyethylene glycerol monostearate, polyoxyethylene glycerol monooleate, and the like); polyoxyethylene aliphatic esters (polyethylene glycol monolaurate, polyethylene glycol monooleate, and the like); polyoxyethylene alkylamines; acetylene glycols (e.g., 2,4,7,9-tetramethyl-5-decyne-4,7-diol, ethylene oxide and propylene oxide adducts of the diol, and the like); and the like. Polyoxyalkylene alkylethers are preferable. The nonionic surfactant may be contained either in the coating solution for ink receiving layer (first solution) or the basic solution (second solution). The nonionic surfactants may be used alone or in combination of two or more.

The amphoteric surfactants include amino acid-type, carboxy ammonium betaine-type, sulfone ammonium betaine-type, ammonium sulfate ester betaine-type, imidazolium betaine-type, and other surfactants. For example, the amphoteric surfactants described in U.S. Pat. No. 3,843,368, JP-A Nos. 59-49535, 63-236546, 5-303205, 8-262742, and 10-282619, and the like may be favorably used. Amino acid-type amphoteric surfactants are preferable as the amphoteric surfactant. Examples of the amino acid-type amphoteric surfactants include those described in JP-A No. 5-303205, i.e., N-acylamino acids having a long chain acyl group and the salts thereof, which are induced from amino acids (glycine, glutamic acid, histidine, and the like). These amphoteric surfactants may be used alone or in combination of two or more.

Examples of the anionic surfactants include aliphatic acid salts (e.g., sodium stearate, potassium oleate), alkyl sulfate ester salts (e.g., sodium lauryl sulfate, triethylammonium lauryl sulfate), sulfonate salts (e.g., sodium dodecylbenzenesulfonate), alkyl sulfosuccinate salts (e.g., sodium dioctyl sulfosuccinate), alkyl diphenyletherdisulfonate salts, alkyl phosphate salts, and the like.

Examples of the cationic surfactants include alkylamine salts, quaternary ammonium salts, pyridinium salts, imidazolium salts, and the like.

The fluorinated surfactants include compounds prepared via an intermediumte having a perfluoroalkyl group by means of electrolytic fluorination, telomerization, oligomerization or the like. Example of these compounds include perfluoroalkyl sulfonate salts, perfluoroalkyl carboxylate salts, perfluoroalkyl ethylene oxide adducts, perfluoroalkyltrialkylammonium salt, perfluoroalkyl group-containing oligomers, perfluoroalkyl phosphate esters, and the like.

Silicone oils modified with organic groups are preferable as the siliconated surfactant. The siliconated surfactants may have a siloxane structural unit having the side-chain modified with an organic group, or one or both ends of the surfactant modified therewith. The organic group modification includes amino modification, polyether modification, epoxy modification, carboxyl modification, carbinol modification, alkyl modification, aralkyl modification, phenol modification, fluorine modification, and the like.

The content of the surfactant in the coating solution for ink receiving layer is preferably 0.001 to 2.0% and more preferably 0.01 to 1.0% by mass. If two or more coating solutions for the ink receiving layer are used for coating, each of the coating solutions preferably contains the surfactant.

According to the invention, the ink receiving layer preferably contains a high-boiling point organic solvent for prevention of curling. The high-boiling point organic solvent is preferably a water-soluble or hydrophobic organic compound having a boiling point of 150° C. or more under atmospheric pressure. The organic compound may be liquid or solid at room temperature, and may be a low-molecular weight compound or a polymer.

Specific examples thereof include aromatic carboxylate esters (e.g., dibutyl phthalate, diphenyl phthalate, phenyl benzoate, and the like), aliphatic carboxylate esters (e.g., dioctyl adipate, dibutyl sebacate, methyl stearate, dibutyl maleate, dibutyl fumalate, triethyl acetylcitrate, and the like), phosphate esters (e.g., trioctyl phosphate, tricresyl phosphate, and the like), epoxy compounds (e.g., epoxidized soy bean oil, epoxidized aliphatic acid methyl esters, and the like), alcohols (e.g., stearyl alcohol, ethylene glycol, propylene glycol, diethylene glycol, triethylene glycol, glycerol, diethylene glycol monobutylether (DEGMBE), triethylene glycol monobutylether, glycerin monomethyether, 1,2,3-butanetriol, 1,2,4-butanetriol, 1,2,4-pentanetriol, 1,2,6-hexanetriol, thiodiglycol, triethanolamine, polyethylene glycol, and the like), vegetable oils (e.g., soy bean oil, sunflower seed oil, and the like), higher aliphatic carboxylic acids (e.g., linoleic acid, oleic acid, and the like), and the like.

Preparation of Ink Jet Recording Medium

The ink jet recording medium of the invention may be prepared favorably by method of forming the ink receiving layer constituting the medium by adding a cross-linking agent into at lease one of the coating solution for forming ink receiving layer (first solution) containing at least fine particles and a water-soluble resin and the basic solution (second solution), and forming a coated layer by applying the coating solution (first solution) onto the ink solvent absorptive undercoat layer on the support and further crosslinking and hardening by applying the basic solution (second solution) at pH 7.1 or more onto the coated layer, either (1) simultaneously with forming coated layer by applying the coating solution, or (2) before the coated layer obtained by coating the coating solution exhibits falling dry rate when dried (Wet on Wet method).

Addition of the mordant into the second solution allows preparation of the ink receiving layer by any process, for example, by a) preparing a coated layer containing fine particles, a water-soluble resin, and a cross-linking agent and then applying a mordant-containing solution thereon, or b) applying a coating solution containing fine particles and a water-soluble resin and a mordant-containing solution simultaneously. The mordant embedded close to the surface of the ink receiving layer in this manner allows efficient fixing of the colorants contained in ink and improves the water resistance of recorded characters and images. As many mordant agents are present at a particular portion of the ink receiving layer, the colorants in ink for ink jet recording are sufficiently fixed, consequently leading to improvement in color density, suppression of the loss of image definition over time, improvement in the glossiness of printed images, the water resistance of printed characters and images, and ozone resistance. The mordant-containing solution may contain fine particles, a water-soluble resin, a cross-linking agent, and the like. Part of the mordant may also be contained in the first solution. In such a case, the mordant in the first solution may be the same as or different from the mordant in the second solution.

Hereinafter, an example of preparing the first solution, i.e., a coating solution containing a vapor-phase process silica, polyvinyl alcohol, a boron compound and a cationic polymer, will be described below.

First, a vapor-phase process silica and a cationic polymer are added in water (e.g., 10 to 20% by mass), and the resulting mixture is dispersed, for example, at a high-velocity of 10,000 rpm (preferably 5,000 to 20,000 rpm) for 20 minutes (preferably 10 to 30 minutes) by using a high-velocity wet colloid mill (e.g., trade name: CLEARMIX, manufactured by M technique Co., Ltd.), into fine particles dispersion. Then, an aqueous solution containing a boron compound and polyvinyl alcohol is added to the fine particles dispersion (e.g., to a concentration of the silica therein of about ⅓), and the resulting solution is dispersed under the same condition as above. The coating solution thus obtained is a homogeneous sol. A porous ink receiving layer having a three-dimensional network structure is formed by applying the coating solution onto a support according to the following coating method. A pH adjusting agent, other dispersant, surfactant, antifoam agent, anti-static agent, or the like may be added to the first solution if necessary.

Water, an organic solvent, or a mixed solvent thereof may be used as the solvent for preparing the first and second solutions. Examples of the organic solvents include alcohols such as methanol, ethanol, n-propanol, i-propanol, and methoxypropanol; ketones such as acetone and methylethylketone; tetrahydrofuran; acetonitrile; ethyl acetate; toluene; and the like.

The first solution (coating solution for ink receiving layer) may be coated by any one of the methods known in the art, for example, by using an extrusion die coater, air doctor coater, blade coater, rod coater, knife coater, squeeze coater, reverse roll coater, bar coater, or the like.

The second solution (basic solution) is applied simultaneously with or after the application of first solution (coating solution for ink receiving layer). The second solution may be applied before the coated layer exhibits falling dry rate when dried. Namely, the ink receiving layer may be favorably formed by introducing the basic solution during the coated layer exhibits constant-rate drying after application of the coating solution for ink receiving layer. The second solution may contain a mordant.

Here, the phrase “before the coated layer exhibits falling dry rate when dried” indicates a period of several minutes after application of the coating solution for ink receiving layer, wherein the content of the solvent (dispersion medium) in the coated layer decreases over time in the manner of “constant-rate drying”. The period of this “constant-rate drying” is described in, for example, Chemical Engineering Handbook (pp.707 to 712, published by Maruzen Co., Ltd., Oct. 25, 1980).

As described above, the coated layer after application of the first solution is dried commonly at 40 to 180° C. for 0.5 to 10 minutes (preferably, 0.5 to 5 minutes) until the coated layer exhibits falling dry rate. The drying period of course varies according to the amount coated, but is commonly in the above range.

The method of applying the second solution before the coated layer exhibits falling dry rate is, for example, a method of (i) coating the second solution additionally onto the coated layer, (ii) spraying the second solution thereon, (iii) immersing the support on which the coated layer is formed in the second solution, or the like.

With respect to the method (i), the coating method of applying the second solution may be any one of coating methods known in the art such as those using a curtain flow coater, extrusion die coater, air doctor coater, blade coater, rod coater, knife coater, squeeze coater, reverse roll coater, bar coater, and the like. Among them, a coating method whereby the coater does not brought into direct contact with the first coated layer, such as that using an extrusion die coater, curtain flow coater, bar coater or the like, may be preferably used.

The amount of the second solution applied is commonly 5 to 50 g/m² and preferably 10 to 30 g/m².

The second solution is commonly dried and cured after application by heating at 40 to 180° C. for 0.5 to 30 minutes. Preferably, the solution is heated at 40 to 150° C. for 1 to 20 minutes. For example, if the cross-linking agent contained in the first solution is boric acid or a boron compound (e.g., borax), the solution is preferably heated at 60 to 100° C. for 5 to 20 minutes.

Alternatively, if the basic solution (second solution) is preferably applied simultaneously with the coating solution for ink receiving layer (first solution), the first and second solutions may be simultaneously applied onto the support (multi-layer application) and then dried, to form an ink receiving layer. In such a case, the first solution is applied directly onto the support.

The simultaneous application (multi-layer application) may be performed by the coating method using, for example, an extrusion die coater or curtain flow coater. The coated layers formed after the simultaneous application is then dried. The coated layers in such a case are commonly dried by heating at 40 to 150° C. for 0.5 to 10 minutes, preferably, at 40 to 100° C. for 0.5 to 5 minutes.

When the simultaneous application (multi-layer application) is performed, for example, by using an extrusion die coater, two kinds of liquids simultaneously extruded are laminated in the neighborhood of the outlet of the extrusion die coater, i.e., before the liquids are applied onto the support, and applied onto the support as it is. The two layers of coating solutions laminated before application tend to make a crosslinking reaction at the interface of the two solutions before they are applied onto the support, often causing increase in viscosity due to mixing of the two solutions at the neighborhood of the extrusion die coater and sometimes causing troubles in the application operation. Therefore, during the simultaneous application, it is preferable to add a barrier-layer solution (intermediumte-layer solution) between the first and second solutions (simultaneous three-layer application).

The barrier-layer solution is not particularly limited, and examples thereof include an aqueous solution containing a trace amount of water-soluble resins, water, and the like. The water-soluble resins are used considering the coating property of the solution, for example, for increasing the viscosity of the solution, and examples thereof are polymers including cellulosic resins (e.g., hydroxypropylmethylcellulose, methylcellulose, hydroxyethylmethylcellulose, and the like), polyvinylpyrrolidone, gelatin, and the like. The barrier-layer solution may contain a mordant.

After formed on the support, the ink receiving layer may be subjected to calendering by passing through roll nips under heat and pressure, for example, by using a super calendering or gloss calendering machine, or the like, for improvement in the surface smoothness, glossiness, transparency, and strength of the coated film. However, because the calendering sometimes causes decrease in void percentage (i.e., decrease in ink absorptive property), it is necessary to set a condition smaller in the decrease in void percentage before calendering.

The roll temperature during calendering is preferably 30 to 150° C. more preferably 40 to 100° C., and the linear pressure between rolls during calendering is preferably 50 to 400 kg/cm and more preferably 100 to 200 kg/cm.

In the case of ink jet recording, the thickness of the ink receiving layer should be decided according to the void percentage of the layer, as the layer should have a sufficient absorption capacity allowing absorption of all droplets. For example, if the ink quantity is 8 nL/mm² and the void percentage is 60%, a film having a thickness of about 15 μm or more is required. Considering the above, ink receiving layer for ink jet recording preferably have a thickness of 10 to 50 μm.

In addition, the diameter of the voids in the ink receiving layer is preferably 0.005 to 0.030 μm as a mediumn size, and more preferably 0.01 to 0.025 μm. The void percentage and the void mediumn size may be determined by using a mercury porosimeter (trade name: “Poresizer 9320-PC2”, manufactured by Shimadzu Corporation).

The ink receiving layer is preferably higher in transparency, and the haze value, an indicator of transparency, of the ink receiving layer formed on a transparent film support is preferably 30% or less and more preferably 20% or less. The haze value may be determined by using a hazemeter (trade name: HGM-2DP, manufactured by Suga Test Instrument Co., Ltd.).

### EXAMPLE

Hereinafter, the present invention will be described in detail with reference to Examples. However, it should be understood that the invention is not restricted to these Examples. In these Examples, ink jet recording sheets are prepared as examples of the ink jet recording medium. The values expressed by “part” and “%” in Examples are those by mass unless otherwise noted, and the degree of polymerization indicates “weight-average polymerization degree”.

### Example 1

Production of Support A

1) Production of the Paper Base Support

100 parts of LBKP wood pulp was beaten to a Canadian freeness of 300 ml by a double disk refiner. Then, 0.5 part of epoxidized behenamide, 1.0 part of anion polyacrylamide, 0.1 part of polyamide polyamine epichlorohydrin, and 0.5 part of cation polyacrylamide respectively by absolute dry weight with respect to the pulp were added thereto, and the resulting slurry was sheeted by a wire paper machine into a base paper having a basis weight of 170 g/m². Subsequently, for adjustment of the surface size of the base paper, a fluorescent brightening agent (trade name: Whitex BB, manufactured by Sumitomo Chemical Co., Ltd.) was added into a 4% aqueous polyvinyl alcohol solution to a concentration of 0.04%, and the base paper was impregnated with the solution to an amount of 0.5 g/m² by absolute dry weight, dried and then calendered, to give a paper base support having a density adjusted to 1.05 g/ml.

2) Preparation of the Coating Solution for Ink Solvent Absorptive Undercoat Layer

First, 100 parts of titanium dioxide (trade name: TIPAQUER-780-2, manufactured by ISHIHARA SANGYO KAISHA, LTD.), 1.2 parts of a 25% solution containing sodium salt of a special polycarboxylic acid-based polymer (trade name: Demol EP, manufactured by Kao Corp.), and 121.7 parts of water were mixed, and the resulting mixture was dispersed in NBK-2 (manufactured by NIPPON SEKI Co., Ltd.) to prepare a 45% titanium dioxide dispersion. Subsequently, 100 parts of a 35% aqueous acrylic latex dispersion (glass transition temperature: 60° C.; minimum layer forming temperature: 50° C.; trade name: Aquabrid 4635, manufacture by DAICEL CHEMICAL INDUSTRIES, LTD.), 43 parts of water, and 35 parts of the 45% titanium dioxide dispersion thus obtained were mixed and stirred well. After stirring, the temperature of the solution was kept at 15 to 25° C., to obtain a 28.6% coating solution for the ink solvent absorptive undercoat layer.

3) Production of the Ink Solvent Absorptive Undercoat Layer

The coating solution for ink solvent absorptive undercoat layer obtained in 2) was coated on the felt surface (surface) of the paper base support obtained in 1) at a dry coating amount of 15 g/m² by a bar coater, and dried to form an ink solvent absorptive undercoat layer (hereinafter, the surface on which this ink solvent absorptive undercoat layer is formed will be referred to as the “front face”). Subsequently, the coating solution for ink solvent absorptive undercoat layer was coated onto the wire surface, reverse face, of the paper base support (i.e., the surface on which the ink solvent absorptive undercoat layer is not formed) at a dry coating amount of 25 g/m² by a bar coater, and dried to form a curling-control layer (hereinafter, the surface on which the curling-control layer is formed will be referred to as the “reverse face”).

4) Soft Calendering

The paper base support having an ink solvent absorptive undercoat layer and a curling-control layer was calendered softly by a soft calendering machine equipped with a pair of metal and resin rolls under the condition of a metal-roll surface temperature of 80° C., the nip pressure of 200 kg/cm, and a traveling speed of 100 m/min, to produce a soft-calendered support A.

Preparation of Ink Jet Recording Sheet

1) Preparation of the Coating Solution for Ink Receiving Layer

A vapor-phase process silicfine particles (1), ion-exchange water (2), and a cationic resin (3), in the amounts described below, were mixed and dispersed in a dispersing machine (trade name: KD-P, manufactured by Shimadzu Enterprises Corp.), to prepare a silica dispersion. Then, an aqueous solution of polyvinyl alcohol (4), boric acid (5), and a polyoxyethylene lauryl ether (6) dissolved in ion-exchange water (7) was added to the silica dispersion, to prepare a coating solution for ink receiving layer. The mass ratio of the fine particles to the water-soluble resin [PB ratio=(1):(4)] was 4.5:1, and the coating solution for ink receiving layer was acidic at a pH of 3.5.

Composition of Coating Solution for Ink Receiving Layer

| | | |
|---|---|---|
| (1) | Vapor-phase process silicfine particles (fine particles) | 10.0 parts |
| | (trade name: REOLOSIL QS-30; average primary | |
| | particles diameter: 7 nm; manufactured by Tokuyama | |
| | Corp.) | |
| (2) | Ion-exchange water | 51.6 parts |
| (3) | Cationic resin (dispersant) | 1.0 part |
| | (trade name: SHALLOL DC-902P; 51% aqueous | |
| | solution; manufactured by Nittobo K.K.) | |
| (4) | 8% Aqueous polyvinyl alcohol solution (water-soluble | 27.8 parts |
| | resin) (trade name: PVA-124, manufactured by Kuraray | |
| | Co., Ltd.; saponification value: 98.5%; and | |
| | polymerization degree: 2,400) | |
| (5) | Boric acid (cross-linking agent) | 0.4 part |
| (6) | Polyoxyethylene laurylether (surfactant) | 1.2 parts |
| | (10% aqueous solution; trade name: Emulgen109P, | |
| | manufactured by Kao Corp.; and HLB value: 13.6) | |
| (7) | Ion-exchange water | 33.0 parts |

2) Coating of the Coating Solution for Ink Receiving Layer

The coating solution for ink receiving layer was coated onto the front face of the support A by using an extrusion die coater at a coating amount of 200 ml/m². Next, a coated layer on the wet support A was dried in a hot air dryer at 80° C. (wind speed: 3 to 8 m/sec), until the solid matter concentration in the coated layer becomes 20%. The coated layer was dried at a constant rate during the period. Immediately after drying, the support A was immersed in a basic solution having the following composition for 30 seconds, allowing the solution to be attached on the coated layer at an amount of 20 g/m², and dried additionally at 80° C. for 10 minutes. In this manner, an ink receiving layer having a dry film thickness of 32 μm was formed on support A, to produce an ink jet recording sheet of the invention (1).

(Composition of the basic solution)

| | |
|---|---|
| Boric acid (cross-linking agent) | 0.65 part |
| Polyallylamine (mordant) | 12.5 parts |
| (20% aqueous solution; trade name: PAA-03, manufactured | |
| by Nittobo K.K.) | |
| Ion-exchange water | 72.0 parts |
| Ammonium chloride (surface pH-adjusting agent) | 0.8 part |
| Polyoxyethylene laurylether (surfactant) | 10 parts |
| (2% aqueous solution; HLB value: 13.6; trade name: | |
| Emulgeh109P, manufactured by Kao Corp.). | |
| Fluorinated surfactant | 2.0 parts |
| (10% aqueous solution; trade name: Megaface F1405, | |
| manufactured by Dainippon Ink and Chemicals, Inc.) | |

### Example 2

An ink jet recording sheet of the invention (2) was produced in the similar manner to Example 1, except that the 35% aqueous acrylic latex dispersion used for “2) Preparation of the coating solution for ink solvent absorptive undercoat layer” in preparing support A of Example 1 was replaced with a 35% aqueous acrylic silicone latex dispersion (glass transition temperature: 25° C.; minimum layer forming temperature: 20° C.; and trade name: Aquabrid ASi-91, manufactured by DAICEL CHEMICAL INDUSTRIES, LTD.).

### Comparative Example 1

A comparative ink jet recording sheet having an ink receiving layer (3) was prepared in the similar manner to Example 1, except that support A of Example 1 was replaced by support B obtained as descried below and a coating solution for ink receiving layer was coated on the front face of support B after corona discharge thereof.

Production of the Support B

100 Parts of LBKP wood pulp was beaten to a Canadian freeness of 300 ml by a double disk refiner. Then, 0.5 part of epoxidized behenamide, 1.0 part of anion polyacrylamide, 0.1 part of polyamide polyamine epichlorohydrin, and 0.5 part of cation polyacrylamide, respectively by absolute dry weight with respect to the pulp, were added thereto, and the resulting slurry was sheeted by a wire paper machine, to give a base paper having a basis weight of 170 g/m². Subsequently, for adjustment of the surface size of the base paper, a fluorescent brightening agent (trade name: Whitex BB, manufactured by Sumitomo Chemical Co., Ltd.) was added to a 4% aqueous polyvinyl alcohol solution to a concentration of 0.04%, and the base paper was impregnated with the solution to an amount of 0.5 g/m² by absolute dry weight. The base paper was dried and then calendered, to give a paper base support having a density adjusted to 1.05 g/ml.

The wire surface (reverse face) of the paper base support thus obtained was subjected to corona discharge. Subsequently, a high-density polyethylene was coated thereon by using a melt extruder to form a matt-surfaced resin layer having a thickness of 19 μm (hereinafter, the resin-layered surface is referred to as the “reverse face”). The resin layer on the reverse face was subjected to corona discharge. Subsequently, an aqueous dispersion containing, as anti-static agents, aluminum oxide (trade name: Alumina Sol 100, manufactured by Nissan Chemical Industries, Ltd.) and silicon dioxide (trade name: Snowtex O, manufactured by Nissan Chemical Industries, Ltd.) at a ratio of 1:2 (mass ratio) was coated at an amount of 0.2 g/m² by dry weight. Further, the felt surface (front face) of the paper base support, not having the resin layer, was subjected to corona discharge. Then, a low-density polyethylene having a melt flow rate (MFR) of 3.8 that contains 10% anatase titanium dioxide, a trace amount of ultramarine, and 0.01% fluorescent whitening agent (with respect to polyethylene) was melt extruded by a melt extruder to form a glossy thermoplastic resin layer having a thickness of 29 μm on the surface of the paper base support (hereinafter, the glossy surface is referred to as the “front face”), to give a resin-coated paper (support B).

### Comparative Example 2

A comparative ink jet recording sheet (4) was produced in the similar manner to Example 1, except that the surface temperature (80° C.) of metal roll in the “4) soft calendering” for preparing support A of Example 1 was change to 50° C.

### Comparative Example 3

A comparative ink jet recording sheet (5) was produced in the similar manner to Example 1, except that in the step for “2) Preparation of the coating solution for ink solvent absorptive undercoat layer” in preparing support A of Example 1, the procedure of adding 43 parts of water and 35 parts of 45% titanium dioxide dispersion to 100 parts of 35% aqueous acrylic latex dispersion was replaced with that of adding 57.5 parts of water to 100 parts of a 45% aqueous acrylic latex dispersion (glass transition temperature: 80° C.; minimum layer forming temperature: 110° C.; trade name: Aquabrid 4722, manufactured by Daicel Chemical Industries, Ltd.) (without addition of the 45% titanium dioxide dispersion), and the surface temperature of metal roll for “4) soft calendering” (80° C.) was changed to 70° C.

Evaluation

The ink jet recording sheets of the invention (1) and (2) and the comparative ink jet recording sheets (3) to (5) obtained respectively in Examples and Comparative examples were evaluated as described below. The results are summarized in the following Table 1.

(1) Evaluation of Glossiness

The glossiness of each ink jet recording sheet was analyzed by using a digital conversion glossmeter (trade name: UGV-5D, manufactured by SUGA TEST INSTRUMENTS Co., Ltd.) at an incident angle of 60° and an acceptance angle of 60°, and evaluated according to the following criteria.
A: Glossiness of 40% or more.
B: Glossiness of 30 to 40%.
C: Glossiness of 30% or less.

(2) Evaluation of Ink Absorptive Property

Solid printing images are printed with Y (yellow), M (magenta), C (cyan), K (black), B (blue), G (green), and R (red) inks on each ink jet recording sheet by using an ink jet printer P (trade name: M-970C, manufactured by Seiko Epson Corp.). A piece of paper is pressed onto the images immediately after printing (in about 10 seconds), and the transfer of image ink to the paper was observed visually and evaluated according to the following criteria.
A: No transfer of ink to test piece.
B: Slight transfer of ink to test piece.
C: Part of an image transferred to test piece (insufficient ink absorption).
   (3) Evaluation of Image Quality

Portrait and landscape images were printed on each ink jet recording sheet by using an ink jet printer P (trade name: M-970C, manufactured by Seiko Epson Corp.), and observed visually. The image quality was classified according to the following criteria.
A: Image quality was sharp and very favorable.
B: Image quality was favorable.
C: Image quality was practically allowable but not satisfactory.
D: Image quality is unfavorable.

(4) Evaluation of Bleeding Over Time

Thin grid pattern images (line width: 0.28 mm) were printed side by side respectively with magenta and black inks on each ink jet recording sheet by using an ink jet printer P (trade name: M-900C, manufactured by Seiko Epson Corp.). The visual concentration D¹ thereof was determined by a visual densitometer (trade name: X-Rite 310TR, manufactured by X-Rite Inc.). The printed sheet was left for 3 hours after printing, additionally for one day in a thermo-hygrostat at a temperature of 40° C. and a relative humidity of 90%, and then the visual concentration D² was determined in the similar manner. The concentration difference ΔOD (=D¹−D²) thus obtained was used as an indicator for evaluation of the ink bleeding over time. A smaller concentration difference (ΔOD) indicates greater suppression of ink bleeding over time.

TABLE 1

| | | | Thermoplastic resin fine particles | | Calendering | | | | |
|---|---|---|---|---|---|---|---|---|---|
| | | | | Minimum layer forming | temperature | | Ink absorptive | Image | Bleeding |
| | Sheet | Pigment | Tg^{(*1)} [° C.] | temperature [° C.] | [° C.]^{(*2)} | Glossiness | property | quality | over time |
| Example 1 | (1) | ◯ | 60 | 50 | 80 | B | A | B | A |
| Example 2 | (2) | ◯ | 25 | 20 | 80 | A | A | B | A |
| Comparative | (3) | ◯ | -(resin-coated) | | | A | A | A | C |
| example 1 | | | | | | | | | |
| Comparative | (4) | ◯ | 60 | 50 | 50 | C | A | C | A |
| example 2 | | | | | | | | | |
| Comparative | (5) | X | 80 | 110 | 70 | C | A | D | A |
| example 3 | | | | | | | | | |

^{(*1)}Tg represents glass transition temperature.
^{(*2)}Calendering temperature represents the surface temperature of metal roll during soft calendering.

As apparent from the Table 1 above, ink jet recording sheets employing the support according to the invention (1) and (2), even though the support is made of a paper base support, have high glossiness and a favorable ink absorptive property and provide images superior in image quality without ink bleeding over time. In contrast, the comparative ink jet recording sheet (3) employing a conventional support which does not have an ink solvent absorptive undercoat layer similar to those in Examples and having a resin-coated surface on the paper base support, did not allow prevention of the loss of image definition over time due to lingering ink solvent, although favorable in glossiness, ink absorptive property, and image quality. In addition, the comparative ink jet recording sheets (4) and (5), which were calendered at low temperature, were unsatisfactory in glossiness and inferior in image quality. Further, the ink jet recording sheet (5) not containing a white pigment was still lower in image quality.

1. An ink jet recording medium comprising;
a support and an ink receiving layer formed thereon,
wherein the support comprises a composition having thermoplastic resin fine particles and a white pigment at least on the receiving layer forming surface side on which the ink receiving layer is formed, and the support is subjected to heating and pressing treatment in a temperature range of not less than the glass transition temperature of the thermoplastic resin fine particles.

2. An ink jet recording medium according to claim 1, wherein the thermoplastic resin fine particles comprise at least one selected from the group consisting of acrylic latexes, acrylic silicone latexes, acrylic epoxy latexes, acrylic styrene latexes, acrylic urethane latexes, styrene-butadiene latexes, acrylonitrile-butadiene latexes, and vinyl acetate latexes.

3. An ink jet recording medium according to claim 1, wherein the thermoplastic resin fine particles have a glass transition temperature of 5 to 70° C.

4. An ink jet recording medium according to claim 1, wherein the thermoplastic resin fine particles have a minimum layer forming temperature of 5 to 60° C.

5. An ink jet recording medium according to claim 1, wherein the white pigment is titanium oxide.

6. An ink jet recording medium according to claim 1, wherein the white pigment has a refractive index of 1.5 or more.

7. An ink jet recording medium according to claim 1, wherein the white pigment has a specific surface area as determined by the BET method of less than 100 m²/g.

8. An ink jet recording medium according to claim 1, wherein the heating and pressing treatment is a calender treatment carried out by use of a soft calendering machine and/or a super calendering machine in which at least one roll in a pair of metal rolls has a surface temperature of not less than the glass transition temperature of the thermoplastic resin fine particles and the nip pressure between the pair of rolls is 50 to 400 kg/cm.

9. An ink jet recording medium according to claim 1, wherein the support is a paper base support.

10. An ink jet recording medium according to claim 9, wherein the support further comprises an ink solvent absorptive undercoat layer, which contains the composition, and is formed at least on the receiving layer forming surface side of the paper base support.

11. An ink jet recording medium according to claim 10, wherein the ink solvent absorptive undercoat layer is formed in an amount of 2 to 20 g/m².

12. An ink jet recording medium according to claim 1, wherein the ink receiving layer contains a water-soluble resin, a cross-linking agent capable of crosslinking the water-soluble resin, fine particles, and a mordant.

13. An ink jet recording medium according to claim 12, wherein the water-soluble resin comprises a polymer selected from the group consisting of polyvinyl alcohol resins, cellulosic resins, ether bond-containing resins, carbamoyl group-containing resins, carboxyl group-containing resins, and gelatins.

14. An ink jet recording medium according to claim 12, wherein the fine particles comprises a substance selected from the group consisting of silicfine particles, colloidal silica, aluminfine particles, and pseudoboemite.

15. An ink jet recording medium according to claim 1, wherein the ink receiving layer is a layer formed by crosslinking a coated layer prepared by coating a coating solution containing at least one fine particles and a water-soluble resin, and the crosslinking and curing are carried out such that a cross-linking agent is added to at least one of the coating solution and a basic solution having a pH of 7.1 or more, and the basic solution is added to the coated layer (1) simultaneously with application of the coating solution for forming the coated layer or (2) during the period of drying the coated layer formed by applying the coating solution, and before the coated layer exhibits a falling dry rate.
